(19) United States
(12) Patent Application Publication
(10) Pub. No.: US 2026/0103386 A1
(43) Pub. Date: Apr. 16, 2026

(54) Batch Process For Silica Generation

(71) Applicant: ECOLAB USA INC., St. Paul, MN (US)

(72) Inventors: Zhi Chen, Eagan, MN (US); Shawnee Marie Wilson, Eagan, MN (US); Qianhe Wang, Eagan, MN (US)

(21) Appl. No.: 19/354,645

(22) Filed: Oct. 9, 2025

Related U.S. Application Data
(60) Provisional application No. 63/706,111, filed on Oct. 11, 2024.

(51) Int. Cl. C01B 33/143

(52) U.S. Cl. CPC C01B 33/143; C01P 2006/12; C01P 2006/22

(57) ABSTRACT

An improved batch process for making silica onsite is provided. Optionally, a pH buffer system is used for accurate pH control and as a method to offset the variation of caustic and acid concentration in the raw materials. The turbidity measurement is used as an indication for reaction termination.

### CROSS REFERENCE TO RELATED APPLICATIONS

This application claims priority to U.S. Application No. 63/706,111, filed on Oct. 11, 2024, the contents of which are hereby incorporated by reference in its entirety.

### FIELD OF THE INVENTION

The invention relates to a batch process for making silica for papermaking.

### BACKGROUND

Silica plays a vital role in paper making by improving retention, drainage, formation, sheet structure, surface properties, sizing and strength.

Several practical factors currently limit commercial use of silica. For instance, silica necessarily are dilute, making it impractical to ship large volumes long distances. Also, silica is prone to gel and to form silicate deposits in equipment used to prepare the product. These problems can be overcome by equipment design and trained personnel in a factory environment, but present greater difficulty in field applications where the equipment should be relatively easy to operate and maintain. Preparation of silica typically occurs via a continuous or batch process.

Batch process reactions allow for the monitoring of silica formation and terminating the reaction before gel formation occurs and the viscosity becomes too high. Batch process reactions allow for easy cleaning of the deposit, easier control on the dilution step and can be used for both unmodified and modified silica production. However, traditionally batch process involves producing and aging the silica in large mixing and holding tanks, which not only are expensive but also introduce the problems of product nonuniformity and process control inherent in a batch process.

In contrast to the batch process, the continuous process involves silica production occurring consistently without stopping. Continuous reactions typically run the risk of gel formation in the process pipe and stopping flow or the structure of the silica product is not optimized for performance. Additionally, continuous reactions can be challenging due to the need for precise control on pH, difficulty of cleaning deposit, and dependency of flow rate on the reaction. Despite these setbacks, silica is typically prepared commercially using a continuous method.

The present disclosure discloses an improved batch process for preparing silica that overcomes the challenges of using a batch process on a commercial scale.

This background information is provided for the purpose of making information believed by the applicant to be of possible relevance to the present invention. No admission is necessarily intended, nor should it be construed, that any of the preceding information constitutes prior art against the present invention. In addition, the preceding information should not be construed to mean that a search has been made or that no other pertinent information as defined in 37 CFR § 1.56(a) exists.

### SUMMARY

The present disclosure provides a stable and feasible batch process for making silica.

One aspect of the invention pertains to a batch process for preparing silica, said process comprising:
a) mixing a silicate salt (e.g. sodium silicate, calcium silicate, ammonium silicate or potassium silicate), an acid, and a capacity buffer (such as boric acid, carbonate buffer, ammonium hydroxide, or Tris buffer), and water in a vessel (e.g., reaction tank) to obtain a mixture, wherein said mixture has a starting pH in the range of about 8.5 to about 10 (or about 9 to about 9.5);
b) aging said mixture for a period of time sufficient to obtain a turbidity in the range of about 10 NTU to about 50 NTU; to obtain unmodified silica, wherein said silica have a S-value of about 2 to about 10 or about 4 to about 10, and
c) diluting said mixture with water to obtain silica with a concentration of about 0.1 wt. % to about 3 wt. %, or about 2.4 wt. % to about 2.6 wt. %.

Another aspect of the invention pertains to an unmodified silica prepared according to a batch process for preparing silica disclosed herein.

A further aspect of the invention pertains to modified silica prepared according to a batch process for preparing silica disclosed herein.

A yet further aspect of the invention pertains to a retention aid composition, said composition comprising unmodified silica and a buffer (e.g. boric acid).

A yet further aspect of the invention pertains to a retention aid composition, said composition comprising modified silica and a buffer (e.g. boric acid).

### BRIEF DESCRIPTION OF THE FIGURES

The patent or application file contains at least one drawing/photograph executed in color. Copies of this patent or patent application publication with color drawing(s) will be provided by the Office upon request and payment of the necessary fee.

FIG. 1. Schematic of batch process method of on-site silica generation.

FIG. 2. Scatterplot of gel time(s) vs pH.

FIG. 3. pH curve of on-site silica generation (buffered vs unbuffered).

FIG. 4. Turbidity and S-value vs reaction time.

FIG. 5. Viscosity vs. reaction time.

FIG. 6. White water turbidity reduction response.

FIG. 7. Drainage comparison between samples and N9000 benchmark.

FIG. 8. Aluminum modified and unmodified silica charge density measurement under pH 5.2.

FIG. 9. Drainage percent improvement of modified silica over N9000 benchmark.

FIG. 10. Retention percent improvement of modified over N9000 benchmark.

FIG. 11a. On-site silica particle and structure image.

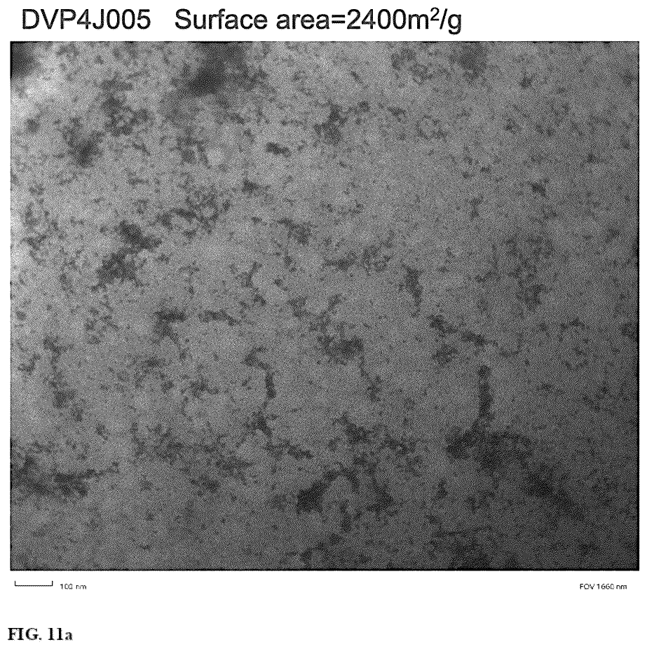

FIG. 11b. Benchmark N9000 particle and structure image.

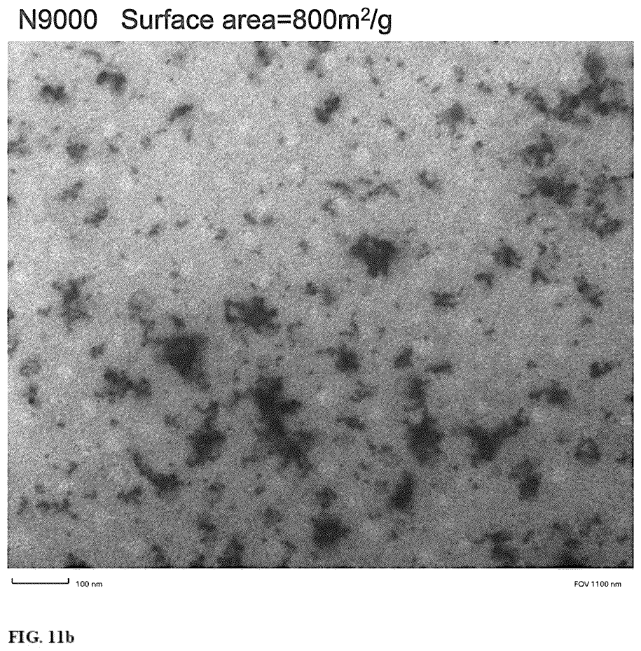

FIG. 12. On-site silica dilution ratio optimization based on performance stability.

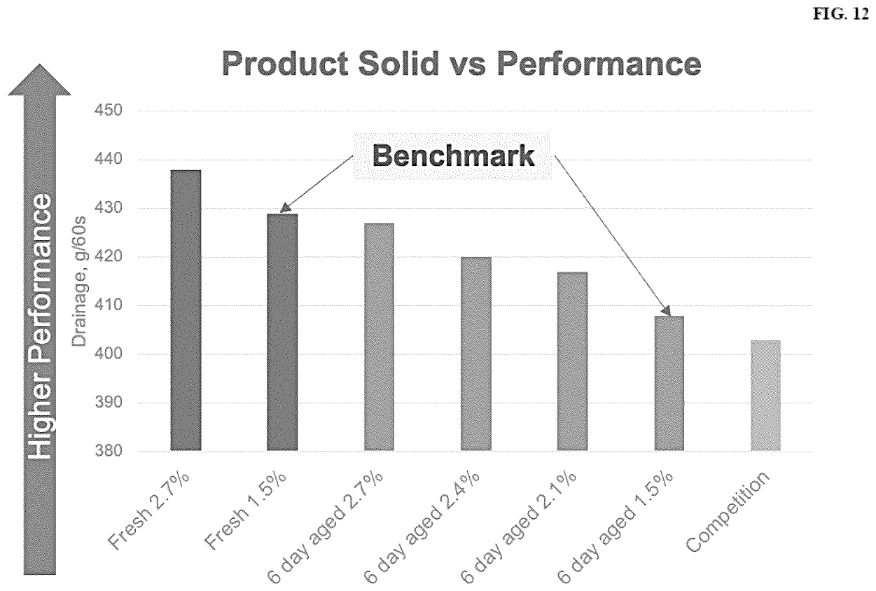

### DETAILED DESCRIPTION

### Definitions

The following definitions are provided to determine how terms used in this application, and in particular, how the claims are to be construed. The organization of the definitions is for convenience only and is not intended to limit any of the definitions to any particular category.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

The terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

“Consisting essentially of” means that the methods and compositions may include additional steps, components, ingredients or the like, but only if the additional steps, components and/or ingredients do not materially alter the basic and novel characteristics of the claimed methods and compositions.

The term “viscosity” as used herein refers to the internal friction or molecular attraction of a given material which manifests itself in resistance to flow. It is measured in liquids by standard test procedures and is usually expressed in poise or centipoise (cP) at a specified temperature. The viscosity of a fluid is an indication of a number of behavior patterns of the liquid at a given temperature including pumping characteristics, rate of flow, wetting properties, and a tendency or capacity to suspend an insoluble particulate material. As used herein, viscosity is based on measurement at ambient temperature and at about 3% to about 15% concentration solids of the reaction solution.

“Papermaking process” means any portion of a method of making paper products from pulp comprising forming an aqueous cellulosic papermaking furnish, draining the furnish to form a sheet and drying the sheet. The steps of forming the papermaking furnish, draining and drying may be carried out in any conventional manner generally known to those skilled in the art. The papermaking process may also include a pulping stage, i.e. making pulp from a lignocellulosic raw material and bleaching stage, i.e. chemical treatment of the pulp for brightness improvement, papermaking is further described in the reference Handbook for Pulp and Paper Technologists, 3rd Edition, by Gary A. Smook, Angus Wilde Publications Inc., (2002) and The Nalco Water Handbook (3rd Edition), by Daniel Flynn, McGraw Hill (2009) in general and in particular pp. 32.1-32.44. “Papermaking process” includes methods of making paper products from pulp comprising forming an aqueous cellulosic papermaking furnish, draining the furnish to form a sheet and drying the sheet. The steps of forming the papermaking furnish, draining and drying may be carried out in any conventional manner generally known to those skilled in the art. Conventional microparticles, alum, cationic starch or a combination thereof may be utilized as adjuncts with the polymer treatment of this invention, though it must be emphasized that no adjunct is required for effective dewatering activity.

“Surface Strength” means the tendency of a paper substrate to resist damage due to abrasive force.

“Dry Strength” means the tendency of a paper substrate to resist damage due to shear force(s), it includes but is not limited to surface strength.

“Wet Strength” means the tendency of a paper substrate to resist damage due to shear force(s) when rewet.

“Wet Web Strength” means the tendency of a paper substrate to resist shear force(s) while the substrate is still wet.

“Substrate” means a mass containing paper fibers going through or having gone through a papermaking process, substrates include wet web, paper mat, slurry, paper sheet, and paper products.

“Paper Product” means the end product of a papermaking process it includes but is not limited to writing paper, printer paper, tissue paper, cardboard, paperboard, and packaging paper.

The term “batch process for preparing silica” as used herein refers to preparing silica in batching. For instance, stropping production of growth of silica (i.e., gel formation) after a desired parameter is achieved, such as turbidity, S-value, etc. In some embodiments, the term “batch process for preparing silica” refers to a process comprising:
a) mixing a silicate salt, an acid, and a capacity buffer, and water in a vessel (to obtain a mixture, wherein said mixture has a starting pH in the range of about 8.5 to about 10 (or about 9 to about 9.5);
b) aging said mixture for a period of time sufficient to obtain a desired turbidity to obtain unmodified silica, wherein said silica have a S-value of about 2 to about 10, and

diluting said mixture with water to obtain silica with a concentration of about 0.1 wt. % to about 3 wt. %, or about 2.4 wt. % to about 2.6 wt. %.

The term “continuous process for preparing silica” refers to the continuous process involves silica production occurring consistently without stopping.

The term “on-site” as used herein refers to the location where the silica will be used, such as a paper mill. Accordingly, as disclosed herein an on-site batch process for the preparation of silica refers to instances where the silica is prepared and consumed in the same or in a nearby location. For example, the silica is prepared at the same location or nearby vicinity of the paper mill where the silica will be used in the papermaking process.

The term “turbidity” as used herein refers to measurement of the level of gel formation during silica preparation. Turbidity may be measured using a conventional turbidimeter, such as SURFACE SCATTER 7SC turbidimeter, a continuous-monitoring instrument designed for measuring turbidity in fluids. The instrument design is based on the nephelometric principle, where light scattered by particles suspended in the fluid is measured to determine the relative amount of particulate matter in the fluid.

During the papermaking processing, a retention aid or retention aid system comprising one more components is generally added to a pulp/filler suspension to form what is referred to in the paper-making art as the “furnish” to retain the filler in the resulting paper sheet. Retention aids are typically used to improve retention fine of particles and fillers during the formation of paper. They can also be used to improve the retention of other papermaking chemicals, including sizing and cationic starches. The term “retention aid composition” is used interchangeably with the terms “retention agent” and “retention aid” to refer a composition comprising unmodified silica or modified silica prepared according to methods disclosed herein and an optionally a buffer (e.g. boric acid). The buffer may be present in the range of about 0% to about 50%.

The term “S-value” as used herein refers to the measure of the degree of microaggregation of colloidal materials (such as silica), it can be obtained from measurements of viscosity of the colloidal system and is often related to the performance of the colloidal end product, its exact metes and bounds and protocols for measuring it are elucidated in The Chemistry of Silica: Solubility, Polymerization, Colloid and Surface Properties and Biochemistry of Silica, by Ralph K. Iler, John Wiley and Sons, Inc., (1979).

“Solids %” means the portion of an aqueous system by weight that is silica bearing particles of the continuous phase.

The term “modified silica” as used herein refers to partial replacement of silicon atoms with other elements such as Boron and aluminum. If the aluminum appears homogeneously in the silica particle, it is called homogenous modification; if the aluminum appears only near the surface layer of silica particle, it is called surface modification.

The term “unmodified silica” as used herein refers to the silica particle that is mainly formed by silicon dioxide structure without purposely swapping of silicon atoms with other elements.

“Capacity buffer” refers to the chemical in solution to stabilize the pH near its pKa value. Capacity level is defined as the molar ratio of the buffer molar concentration to the total acid molar concentration.

In the event that the above definitions or a description stated elsewhere in this application is inconsistent with a meaning (explicit or implicit) which is commonly used, in a dictionary, or stated in a source incorporated by reference into this application, the application and the claim terms in particular are understood to be construed according to the definition or description in this application, and not according to the common definition, dictionary definition, or the definition that was incorporated by reference. In light of the above, in the event that a term can only be understood if it is construed by a dictionary, if the term is defined by the Kirk-Othmer Encyclopedia of Chemical Technology, 5th Edition, (2005), (Published by Wiley, John & Sons, Inc.) this definition shall control how the term is to be defined in the claims.

The present disclosure provides a beneficial method for generating silica on-site using a batch process method. The methods disclosed herein advantageously provides a stable and feasible process for onsite silica generation, target reduced cost over current plant manufactured silica products in the market to capture more market share, and is able to expand the silica application to regions with high temperatures that prohibited the application of current silica products with limited shelf life. Additionally, the methods disclosed herein results in stable product performance and allows for optional surface modification to make aluminum modified silica onsite

Batch processing of silica disclosed herein may be performed onsite in the present disclosure, namely at (or near) the location where the silica will be used, such as a paper mill. On-site generation is more cost effective due to the reduced shipping and packaging costs and overhead costs. Additionally on-site silica generation will ease the manufacturing capacity pressure. There is also no shelf-life concern with this approach, and the generated silica has a potential active performance gain of about 15% improvement.

One aspect of the invention pertains to a retention aid composition comprising sodium silicate, an acid (inorganic or organic), and buffer acid, which are added to a reaction tank within a desired ratio. The pH, viscosity and/or turbidity may be monitored during the reaction. Once the turbidity reaches the control limit, the solution is pumped out of the reaction tank and diluted with extra water. The dilution using water may be effectively stop further reaction. In some instances, an aluminum source may be added together with the dilution water to modify the surface of silica particle.

A further aspect of the invention pertains to a batch process for preparing silica, said process comprising:
a) mixing a silicate salt (e.g. sodium silicate, calcium silicate, ammonium silicate or potassium silicate), an acid, and a capacity buffer (such as boric acid, carbonate buffer, ammonium hydroxide, or Tris buffer), and water in a vessel (e.g., reaction tank) to obtain a mixture, wherein said mixture has a starting pH in the range of about 8.5 to about 10 (or about 9 to about 9.5);
b) aging said mixture for a period of time sufficient to obtain a turbidity in the range of about 10 NTU to about 50 NTU; to obtain unmodified silica, wherein said silica have a S-value of about 3 to about 20, about 2 to about 10, or about 4 to about 10, and
c) diluting said mixture with water to obtain silica with a concentration of about 0.1 wt. % to about 3 wt. %, or about 2.4 wt. % to about 2.6 wt. %.

In some embodiments, the unmodified silica disclosed herein has a S-value in the range of about 3 to about 20, turbidity in the range of about 10 NTU to about 40 NTU, solid content in the reaction is in the range of about 2% to about 6%, the viscosity is less than 50 cps, and the particle size is about 0.5 nm to about 6 nm, about 1 nm to about 3 nm, about 1 nm to about 2 nm, or about 1 nm to about 1.5 nm.

The reaction between silicate salt and acid and particle growth is very quick. The speed of the reaction is sensitive to pH, conductivity, and the concentration of the reactants.

Another aspect of the invention pertains to a batch process for preparing silica comprising:
a) mixing a retention aid, an acid, and a capacity buffer in a reaction tank, the mixture having a starting pH in the range of about 9 to about 9.5; and
b) aging the mixture in said reaction tank for a period of time sufficient for the turbidity to be in the range of about 10 NTU to about 50 NTU and the solid content in the mixture is in the range of about 2% to about 6%; and
c) transferring the mixture to a vessel, such as a daytank, and diluting said mixture with water to a silica concentration of about 0.1 wt. % to about 3 wt. %, or about 2.4 wt. % to about 2.6 wt. %.

In some embodiments, said silica is prepared on-site in a batch, (e.g., a semi-batch, or a full batch).

In some embodiments, said mixture of step (b) is aged for about 5 minutes to about 60 minutes, or about 20 minutes to about 40 minutes.

In some embodiments, said mixture of step (b) has a final pH in the range of about 7 to about 9.

In some embodiments, the dilution of step (c) involves dilution to a ratio (water:silica) of about 1:1 to about 100:1, or about 3:1.

A further aspect of the invention pertains to a retention aid composition, said composition comprising unmodified silica, acid, and capacity buffer in reaction tank, wherein said silica has a S-value in the range of about 3 to about 20.

In some embodiments, said mixture of step (b) has turbidity in the range of about 10 NTU to about 40 NTU after aging.

In further embodiments, said mixture of step (b) has a solid content in the reaction is in the range of about 2% to about 6% after aging.

In some embodiments, said mixture of step (b) has the viscosity is less than 50 cps after aging.

In further embodiments, said unmodified silica has a particle size is about 2 nm to about 6 nm.

In further embodiments, said unmodified silica has said s-value is in the range of about 4 to about 10.

In some embodiments, said mixture in step (b) has a solid content in the reaction of about 3%.

In some embodiments, said unmodified silica particles have a surface area of about 500 m²/g to about 6000 m²/g, or about 2000 m²/g to about 3000 m²/g.

In some embodiments, said silicate salt is sodium silicate, calcium silicate, ammonium silicate or potassium silicate.

In some embodiments, said acid is citric acid, butanetetracarboxylic acid, cyclopentane tetracarboxylic acid, malic acid, succinic acid, polyacrylic acid, nitric acid, hydrochloric acid, or sulfuric acid.

In some embodiments, said acid is added said mixture of step (a) has a starting pH to achieve and/or reach a pH of about 7 to about 10, or about 8.5 to about 10;

In some embodiments, said buffer is about 0% to about 50% capacity or about 10% capacity.

In some embodiments, said buffer is boric acid.

A further aspect of the invention pertains to a retention aid composition, said composition comprising modified silica, an acid, a buffer, and an aluminate salt, wherein said silica has a s-value of about 2 to about 15.

In some embodiments, said aluminate salt is sodium aluminate, potassium aluminate, or calcium aluminate.

In some embodiments, said aluminate salt has a concentration of less than about 0.2 mol/L or less than about 0.04 mol/L.

In some embodiments, said aluminate salt and silica are present in a molar ratio in the range of about 0.02 to about 0.30 or about 0.05 to about 0.07.

### Embodiments

A non-limiting list of embodiments is provided below:
1. A batch process for preparing silica, said process comprising:
   a) mixing a silicate salt in the range of about 26% to about 29%, an acid, and a capacity buffer, and water in a vessel to obtain a mixture, wherein said mixture has a starting pH in the range of about 8.5 to about 10;
   b) aging said mixture for a period of time sufficient to obtain a turbidity in the range of about 10 NTU to about 50 NTU; to obtain unmodified silica, wherein said silica have a S-value of about 2 to about 10 or about 4 to about 10, and
   c) diluting said mixture with water to obtain silica with a concentration of about 0.1 wt. % to about 3 wt. %, or about 2.4 wt. % to about 2.6 wt. %.
2. The process of embodiment 1, wherein said silicate salt is chosen from sodium silicate, calcium silicate, ammonium silicate, potassium silicate, or a combination thereof.
3. The process of embodiment 1, wherein said capacity buffer is chosen from boric acid, carbonate buffer, ammonium hydroxide, Tris buffer, or a combination thereof.
4. The process of embodiment 1, wherein said vessel is a reaction tank.
5. The process of embodiment 1, wherein said starting pH is about 9 to about 9.5.
6. The process of any of the preceding embodiments, wherein the mixture of step (b) is aged for about 5 minutes to about 60 minutes.
7. The process of embodiment 2, wherein the mixture of step (b) is aged for about 20 minutes to about 40 minutes.
8. The process of embodiment 1, wherein the mixture of step (b) has a pH in the range of about 9 to about 10.5.
9. The process of embodiment 1, wherein the dilution of step (c) is in a dilution ratio of about 0.1:1 to about 100:1 (water:silica).
10. The process of embodiment 5, wherein the dilution of step (c) is in a dilution ratio of about 3:1.
11. The process of embodiment 1, wherein said unmodified silica particles have a surface area of about 500 m²/g to about 6000 m²/g, or about 2000 m²/g to about 3000 m²/g.
12. The process of embodiment 1, wherein said acid is an inorganic or organic acid.
13. The process of embodiment 1, wherein said inorganic or organic acid is citric acid, butanetetracarboxylic acid, cyclopentane tetracarboxylic acid, malic acid, succinic acid, polyacrylic acid, nitric acid, hydrochloric acid, or sulfuric acid.
14. The process of embodiment 1, wherein said buffer is about 0% to about 50% capacity.
15. The process of embodiment 1, wherein said buffer is about 10% capacity to about 20% capacity.
16. The process of embodiment 1, wherein said buffer is boric acid, carbonate buffer (such as sodium bicarbonate and/or calcium carbonate), ammonium hydroxide, or Tris buffer.
17. The process of embodiment 1, said process further comprising adding an aluminate salt (such as sodium aluminate) to said water of step (c) to obtain modified silica, wherein said modified silica has an aluminate surface modification molar ratio in the range of about 0.02 to about 0.3 or about 0.05 to about 0.07 (Al:Si).
18. The process of embodiment 13, wherein said aluminum salt is sodium aluminate, potassium aluminate or calcium aluminate.
19. The process of embodiment 13, wherein said aluminate salt has a concentration less than about 0.2 mol/L.
20. The process of embodiment 13, wherein said aluminate salt has a concentration of less than about 0.04 mol/L.
21. The process of embodiment 13, wherein said sodium aluminate and silica is present in a molar ratio in the range of about 0.02 to about 0.30.
22. The process of embodiment 17, wherein said sodium aluminate and silica is present in a molar ratio in the range of about 0.05 to about 0.07.
23. The process of any of the preceding embodiments, wherein said silica is prepared on-site.
24. An unmodified silica prepared according to a method of any of the preceding embodiments.
25. An modified silica prepared according to a method of any of the preceding embodiments.
26. A retention aid composition, said composition comprising unmodified silica according to embodiment 20 and a buffer (e.g. boric acid) in the range of about 0% to about 50%.
27. A retention aid composition, said composition comprising modified silica according to embodiment 21 and a buffer (e.g. boric acid) in the range of about 0% to about 50%.
28. A method for enhancing paper strength and press section dewatering of a paper sheet on a paper machine comprising adding to the paper sheet about 0.05 lb/ton to about 20 lb/ton dry silica based on dry fiber, based on dry fiber of modified silica of any of the preceding claims.
29. A method for enhancing paper strength of a paper sheet on a paper machine comprising adding to the paper sheet about 0.05 lb/ton to about 20 lb/ton, based on dry fiber, of said silica of any of the preceding claims.
30. The process of any of the preceding embodiments, wherein said silica is prepared is prepared onsite in a semi-batch or a full batch.
31. The process of embodiment 1, wherein said silicate salt is sodium silicate, calcium silicate, ammonium silicate or potassium silicate.

### EXAMPLES

The foregoing may be better understood by reference to the following examples, which are presented for purposes of illustration and are not intended to limit the scope of the invention.

### Example 1. Batch Processing Method for the Generation of Silica

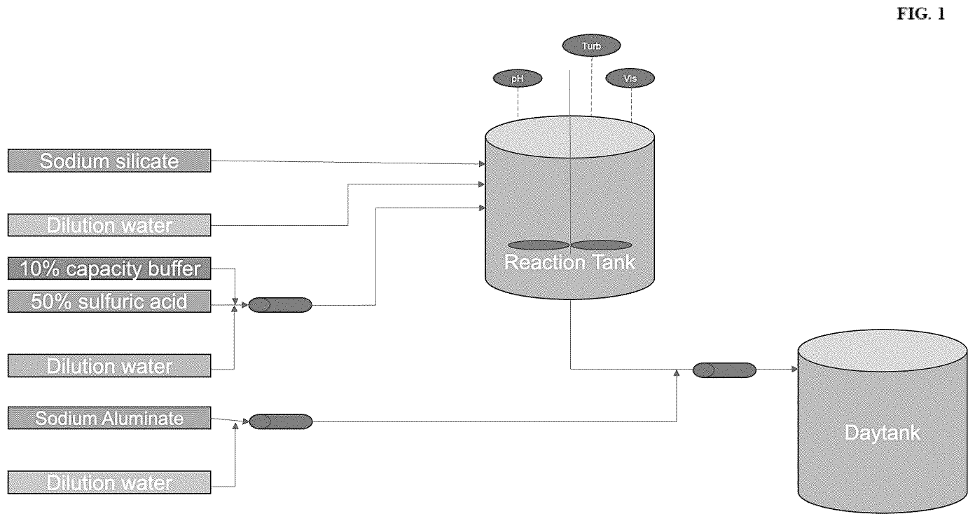

A batch process will be employed for the reaction (FIG. 1). Sodium silicate and acids (inorganic or organic acid and buffer acid) are added to the reaction tank with designed ratio. The pH, viscosity and turbidity will be monitored during the reaction. Once the turbidity reaches the control limit, the solution will be pumped out of the reaction tank and diluted with extra water. The dilution can effectively stop further reaction. Aluminum source can be added together with dilution water to modify the surface of silica particle. Batch reaction results are in Table 1.

TABLE 1
Results from batch process generation of silica on-site

| Silicate solution | | Acid solution | | Silicate | SiO2 solid | | |
|---|---|---|---|---|---|---|---|
| Dilution | | Dilution | | to acid | contend | Starting | Gel time |
| Water (g) | R-50599 (g) | Water (g) | H2SO4 (g) | ratio (g/g) | in reaction | pH | (min) |
| 437 | 107 | 530 | 12.48 | 8.57 | 2.76% | 8.22 | 2 |
| 437 | 107 | 530 | 11.48 | 9.32 | 2.76% | 9.45 | >30 |
| 437 | 107 | 530 | 12 | 8.92 | 2.76% | 8.94 | 10 |
| 437 | 107 | 530 | 12.25 | 8.73 | 2.76% | 8.98 | 8 |
| 437 | 107 | 530 | 11.75 | 9.11 | 2.76% | 9.16 | 40 |
| 437 | 500 | 530 | 54.9 | 9.11 | 9.20% | N/A | Instantly |
| 43.7 | 50 | 53 | 4.67 | 10.71 | 9.25% | N/A | Instantly |
| 80 | 20 | 97.2 | 2.8 | 7.14 | 2.80% | 6.96 | 2.5 |
| 80 | 20 | 97.4 | 2.6 | 7.69 | 2.80% | 5.68 | 23 |
| 80 | 20 | 97.6 | 2.4 | 8.33 | 2.80% | 8.91 | 3.5 |
| 80 | 20 | 97.4 | 2.6 | 7.69 | 2.80% | 7.94 | 1 |
| 80 | 20 | 97.3 | 2.7 | 7.41 | 2.80% | 7.62 | 1.2 |

### Example 2. PH Effect on Silica Generation

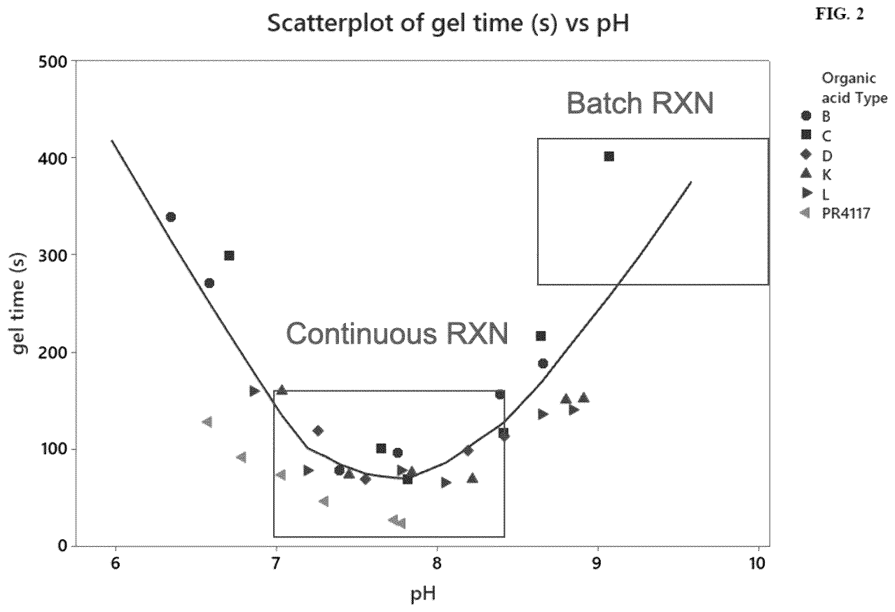

For product quality control, it is recommended to perform the batch reaction in the pH 8.5-10 range. Lowing the pH using different acids (Table 2) increases the reaction speed but also increases the gelling propensity as shown in FIG. 2. Increased reaction speed is more suitable for a continuous reaction, which happens directly in the process pipe. The total reaction time is determined by the flow rate and the pipe size, both which are difficult parameters to adjust.

TABLE 2
Acids

| Acid | Description |
|---|---|
| B | Citric acid |
| C | Butanetetracarboxylic acid |
| D | Cyclopentanetetracarboxylic acid |
| K | Malic acid |
| L | Succinic acid |
| PR-4117 | Polyacrylic acid |

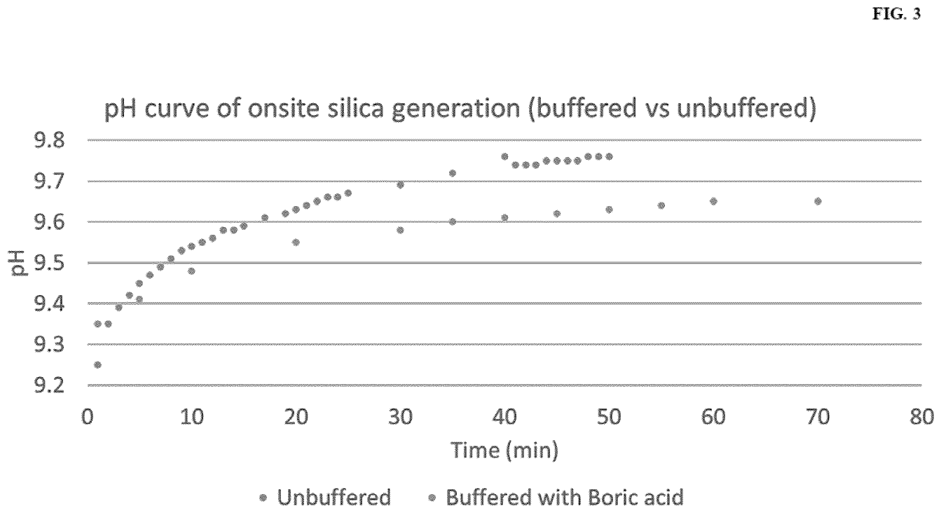

In this reaction, to better tolerate raw material perturbation on the caustic/acid ratio, the proposed batch method uses a buffer acid to better control the pH in a narrower range. Boric acid, with pKa close to 9.2, is an advantageous as it is in the middle of the preferred pH range. As shown in FIG. 3, the pH swing in the reaction is smaller with 15% of mole ratio buffer involved.

### Example 3. Effect of Turbidity, Viscosity and S-Value on Reaction Time

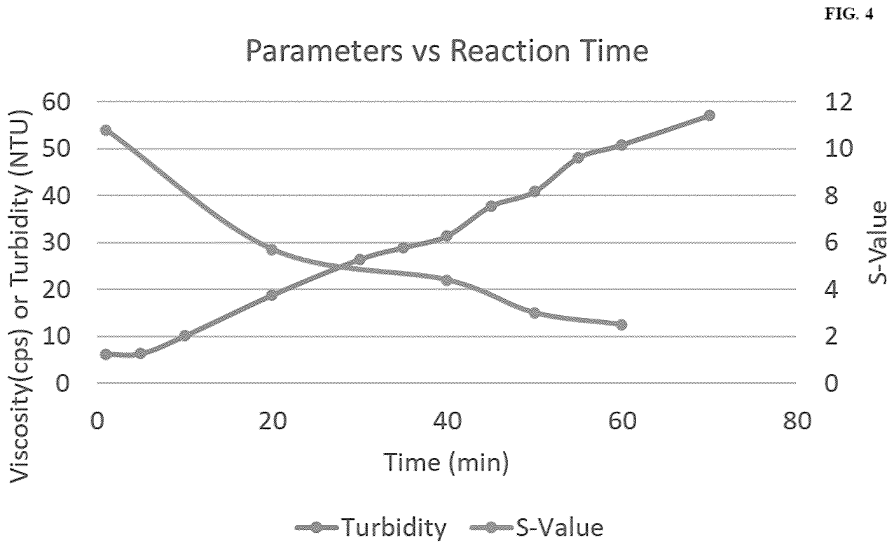

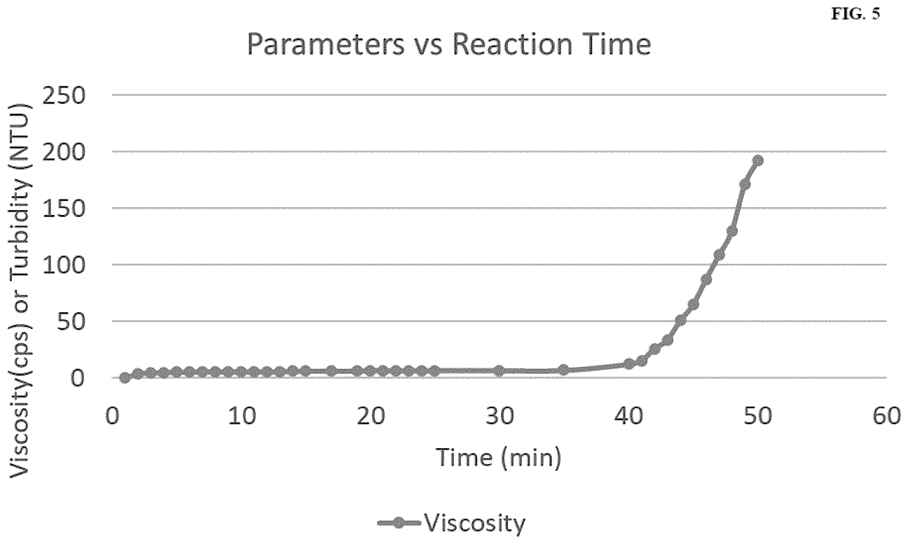

Turbidity was chosen as the measurement used to determine when to terminate the reaction since it is a linear response and easy to monitor (FIG. 4). Viscosity would be a difficult parameter to monitor because it remains steady for a very long time and then sharply increases at the end of the reaction (FIG. 5). The S-value of the silica, which is an indication of the aggregation of the silica particles changes over time (FIG. 4). And viscosity and turbidity also change in the process.

### Example 4. Performance of Generated Unmodified Silica

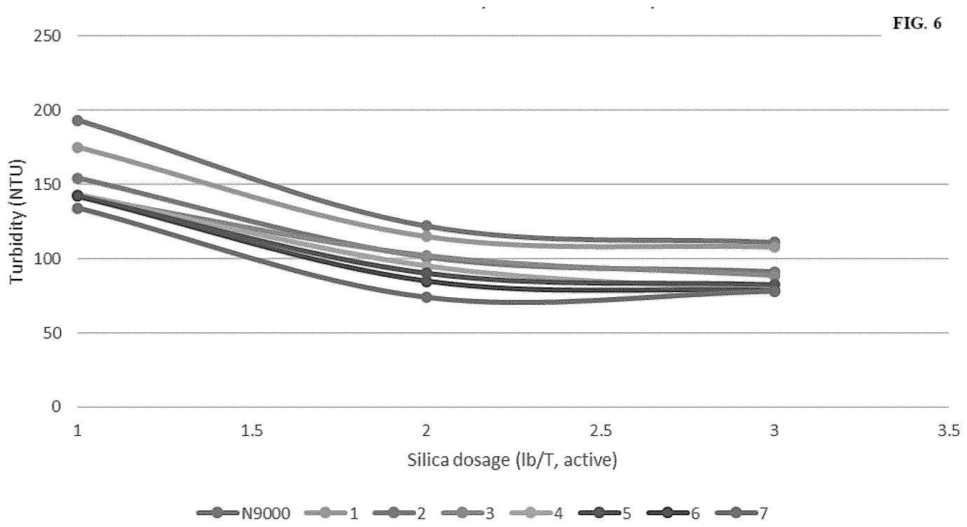

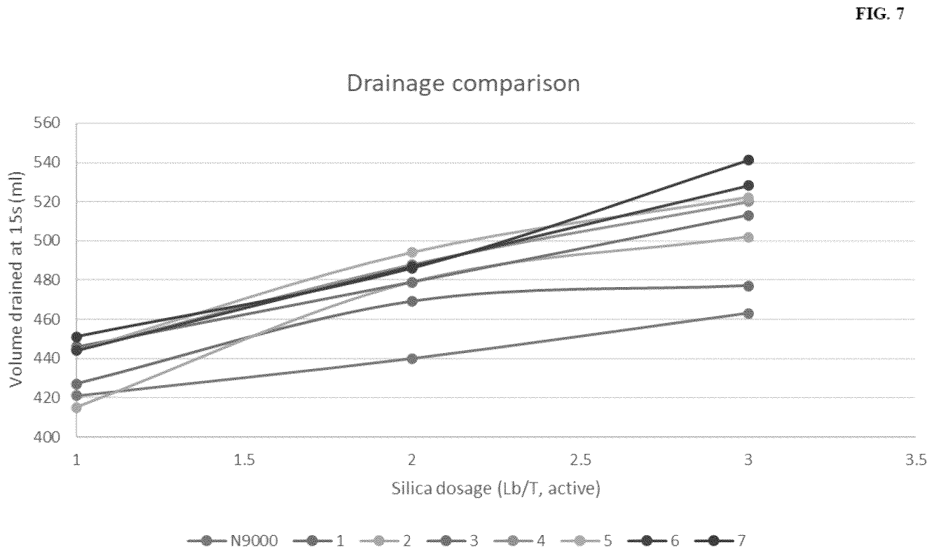

Silica at 1% solid, highly structured from the onsite generation skid. FIG. 6 and FIG. 7 are the performance comparison for sample taken at different reaction time with benchmark N9000 (Table 3).

TABLE 3
Drainage volume at 15 seconds for samples and benchmark N9000

| Sample ID | Reaction Time (min) | Silica Turbidity (NTU) |
|---|---|---|
| N9000 | N/A | N/A |
| 1 | 3 | 5.36 |
| 2 | 10 | 11.1 |
| 3 | 25 | 21.8 |
| 4 | 35 | 29.6 |
| 5 | 45 | 41.3 |
| 6 | 60 | 49.4 |
| 7 | 75 | 61 |

### Example 5. Performance of Generated Modified Silica

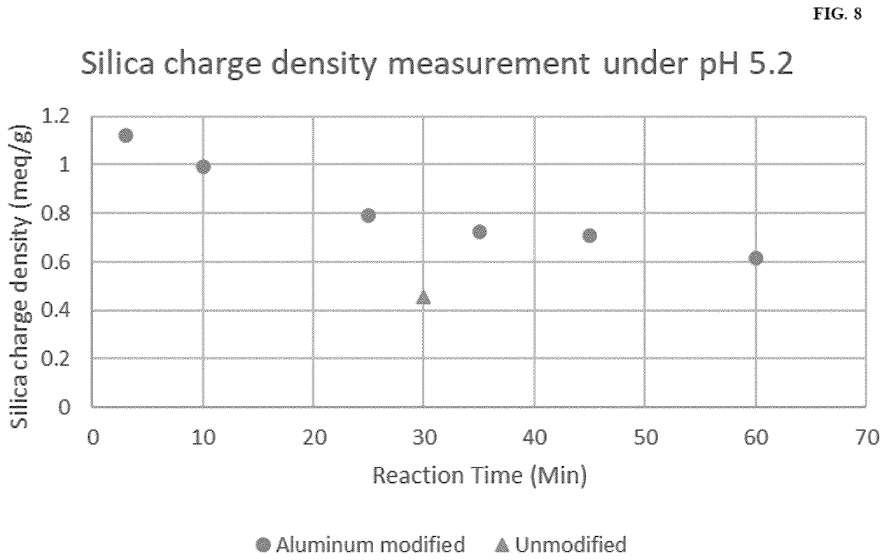

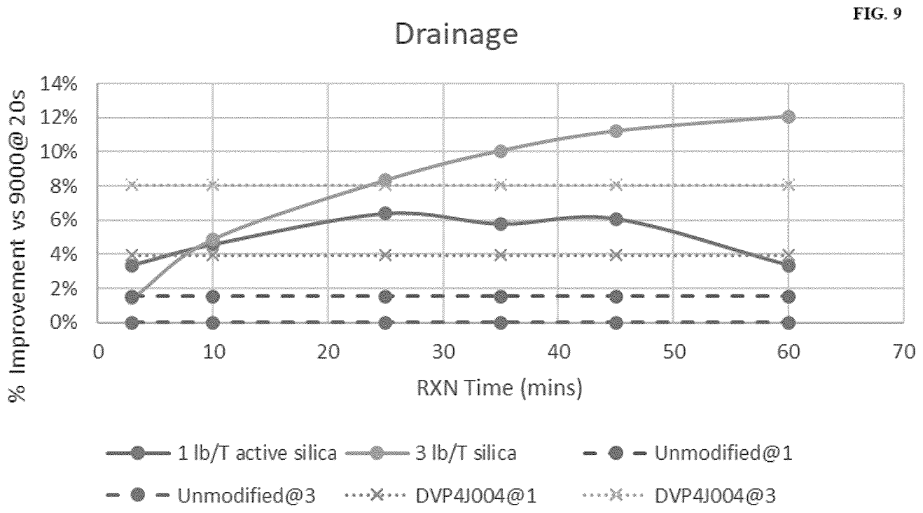

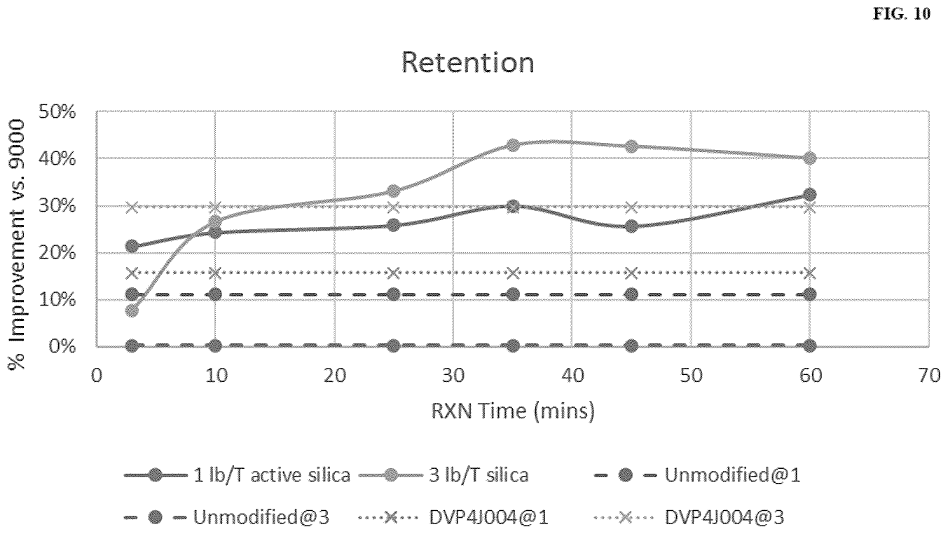

Silica at 0.7% solid, aluminum modified and highly structured from the onsite generation reaction. Table 4 is the performance comparison for sample taken at different reaction time with benchmark N9000. The unmodified sample was taken at 30 mins of reaction, but no aluminum was added for surface modification (FIG. 8). DVP4J004 is the existing aluminum modified silica product from plant, with 10.5% solid content and S-value of about 30. The furnish pH was adjusted to 5.5 for this performance comparison (FIGS. 9 and 10).

TABLE 4
Drainage improvement of samples over N9000 benchmark

| Sample ID | Reaction Time (min) | Turbidity (NTU) |
|---|---|---|
| 1 | 3 | 4.82 |
| 2 | 10 | 8.21 |
| 3 | 25 | 21.8 |
| 4 | 35 | 27.7 |
| 5 | 45 | 34.2 |
| 6 | 60 | 46 |
| Unmodified | 30 | 25 |

All references, including publications, patent applications, and patents, cited herein are hereby incorporated by reference to the same extent as if each reference were individually and specifically indicated to be incorporated by reference and were set forth in its entirety herein.

Embodiments of the present disclosure are described herein, including the best mode known to the inventors for carrying out the invention. Variations of these embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments mentioned herein, described herein and/or incorporated herein. In addition the invention encompasses any possible combination that also specifically excludes any one or some of the various embodiments mentioned herein, described herein and/or incorporated herein.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein, then any such conflicting information in such incorporated by reference material is specifically not incorporated by reference herein.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range. All percentages and proportions herein are by weight unless otherwise specified. G/A (glyoxal to amide) ratios disclosed herein are based on mole ratios. Further, the NMR results disclosed herein are based on mole ratios.

The recitation of any numerical range by endpoints is meant to include the endpoints of the range, all numbers within the range, and any narrower range within the stated range (e.g. 1 to 5 includes 1, 1.5, 2, 2.75, 3, 3.8, 4, and 5). Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

This completes the description of the preferred and alternate embodiments of the invention. Those skilled in the art may recognize other equivalents to the specific embodiment described herein which equivalents are intended to be encompassed by the claims attached hereto.

We claim:

1. A batch process for preparing silica, said process comprising:
a) mixing a silicate salt in the range of about 26% to about 29%, an acid, and a capacity buffer, and water in a vessel to obtain a mixture, wherein said mixture has a starting pH in the range of about 8.5 to about 10;
b) aging said mixture for a period of time sufficient to obtain a turbidity in the range of about 10 NTU to about 50 NTU; to obtain unmodified silica, wherein said silica have a S-value of about 2 to about 10 or about 4 to about 10, and
c) diluting said mixture with water to obtain silica with a concentration of about 0.1 wt. % to about 3 wt. %.

2. The process of claim 1, wherein said silicate salt is chosen from sodium silicate, calcium silicate, ammonium silicate, potassium silicate, or a combination thereof.

3. The process of claim 1, wherein said capacity buffer is chosen from boric acid, carbonate buffer, ammonium hydroxide, Tris buffer, or a combination thereof.

4. The process of claim 1, wherein the mixture of step (b) is aged for about 5 minutes to about 60 minutes.

5. The process of claim 1, wherein the mixture of step (b) has a pH in the range of about 9 to about 10.5.

6. The process of claim 1, wherein the dilution of step (c) is in a dilution ratio of about 0.1:1 to about 100:1 (water:silica).

7. The process of claim 6, wherein the dilution of step (c) is in a dilution ratio of about 3:1.

8. The process of claim 1, wherein said unmodified silica particles have a surface area of about 500 m²/g to about 6000 m²/g.

9. The process of claim 1, wherein said acid is an inorganic or organic acid.

10. The process of claim 1, wherein said buffer is about 0% to about 50% capacity.

11. The process of claim 1, said process further comprising adding an aluminate salt to said water of step (c) to obtain modified silica, wherein said modified silica has an aluminate surface modification ratio in the range of about 0.02 to about 0.3 or about 0.05 to about 0.07 (Al:Si).

12. The process of claim 11, wherein said aluminate salt is sodium aluminate, potassium aluminate or calcium aluminate.

13. The process of claim 11, wherein said aluminate salt has a concentration of less than about 0.04 mol/L.

14. The process of claim 11, wherein said sodium aluminate and silica is present in a molar ratio in the range of about 0.02 to about 0.30.

15. The process of claim 1, wherein said silica is prepared on-site.

16. The process of any of claim 1, wherein said silica is prepared onsite in a semi-batch or a full batch.

17. A silica, wherein said silica is prepared by a process comprising:
a) mixing a silicate salt in the range of about 26% to about 29%, an acid, and a capacity buffer, and water in a vessel to obtain a mixture, wherein said mixture has a starting pH in the range of about 8.5 to about 10;
b) aging said mixture for a period of time sufficient to obtain a turbidity in the range of about 10 NTU to about 50 NTU; to obtain unmodified silica, wherein said silica have a S-value of about 2 to about 10 or about 4 to about 10, and
c) diluting said mixture with water to obtain silica with a concentration of about 0.1 wt. % to about 3 wt. %.

18. The silica of claim 17, wherein said process further comprises adding an aluminate salt to said water of step (c) to obtain modified silica, wherein said modified silica has an aluminate surface modification ratio in the range of about 0.02 to about 0.3 or about 0.05 to about 0.07 (Al:Si).

19. A retention aid composition, said composition comprising unmodified silica according to claim 17 and a buffer in the range of about 0% to about 50%.

20. A retention aid composition, said composition comprising modified silica according to claim 18 and a buffer in the range of about 0% to about 50%.
